(19) United States
(12) Patent Application Publication
(10) Pub. No.: US 2009/0300775 A1
(43) Pub. Date: Dec. 3, 2009

(54) METHOD FOR SHARING RIGHTS OBJECT IN DIGITAL RIGHTS MANAGEMENT AND DEVICE THEREOF

(75) Inventors: Youn-Sung Chu, Seoul (KR); Te-Hyun Kim, Gyeonggi-do (KR); Seung Jae Lee, Seoul (KR); Kiran Kumar, Gyeonggi-do (KR)

Correspondence Address: BIRCH STEWART KOLASCH & BIRCH, PO BOX 747, FALLS CHURCH, VA, 22040-0747, US

(73) Assignee: LG ELECTRONICS INC.

(21) Appl. No.: 12/295,861

(22) PCT Filed: Apr. 5, 2007
(86) PCT No.: PCT/KR07/01659

§ 371 Date: Apr. 20, 2009

(30) Foreign Application Priority Data
Apr. 5, 2006 (KR) 10-2006-0031142
Apr. 11, 2006 (KR) 10-2005-0032978
Jul. 3, 2006 (KR) 10-2006-0062220

(51) Int. Cl. G06F 21/00

(52) U.S. Cl. 726/27

(57) ABSTRACT

A Digital Rights Management (DRM), and particularly a method for sharing a Rights Object (RO) of a certain DRM content between devices, wherein a certain device requests a Rights Issuer (RI) to upgrade its existing RO, and moves or copies the upgraded RO by the request to at least one or more other devices via a wired/wireless medium, thereby sharing the RO with the other devices.

### DISCLOSURE OF INVENTION

### Technical Solution

This disclosure relates to a Digital Rights Management (DRM), and more particularly, to a method for sharing a Rights Object (RO) of a certain DRM content between devices.

A Digital Rights Management (DRM) refers to a system technology for safely protecting rights for digital contents and systematically managing them. The DRM provides a protecting and managing scheme for preventing an illegal copy of the content, acquiring DRM contents RO, and generating and transferring the content.

FIG. 1 illustrates a construction of a DRM system. The DRM system controls content issued to a user by a content provider to be used only in a right-limit of RO. Here, the content provider refers to an entity corresponding to a Content Issuer (CI) and/or a Rights Issuer (RI). T

he CI issues a protected content (i.e., DRM content) using a particular encryption key so as to protect the content from users having no access right therefor, while the RI issues RO required to use the protected content.

A DRM agent is mounted (equipped with) in a terminal thus to receive the protected content and its RO. The DRM agent then analyzes ‘permission’ (license) included in the RO and thus changes the protected content into a format which is usable in the corresponding terminal, thereby controlling the use of the content. Here, the RO for the DRM content may include various types of constraints which are employed when using the corresponding DRM content, for example, ‘count’, ‘interval’ or ‘system’ related to using the corresponding DRM content.

In the meantime, a user of a certain device having bought a RO for a certain DRM content may desire to share his RO (e.g., moving his RO or copying the RO) with unspecified users or a specified user (or another device). Here, in order for the user to share his RO with another user, the RO should be processed to be sharable in a certain manner.

Therefore, it is an object of this disclosure to provide a method for sharing a Rights Object (RO) for a DRM content between devices, and a device thereof.

To achieve the object of this disclosure, there is provided a method for sharing an RO between devices comprising: sending, by a first device, a message for requesting an upgrading of a certain RO to a server (e.g., RI or CI) in order to share the RO; receiving, by the first device, a response message from the server with respect to the RO-upgrading request message; and acquiring, by the first device, an upgraded RO from the RI.

Preferably, the method may further comprise receiving, by the first device, from the server a message for triggering RO-upgrade before sending the RO-upgrade-requesting message to the server.

Preferably, the sharing of the upgraded RO includes: moving the upgraded RO from the first device to a second device; copying the upgraded RO from the first device to the second device; or performing an Ad Hoc sharing for the upgraded RO between the first device and the second device.

To achieve the object of this disclosure, a method for sharing a certain RO between devices comprises: requesting, by a first device, an upgrading of an RO from a server (e.g., RI or CI), in order to share the RO with at least one or more second devices; receiving, by the first device, a response from the server with respect to the RO-upgrading request; and receiving, by the first device, an upgraded RO issued by the server based on state information in the received response.

To achieve the object of this disclosure, a device comprises: a transceiver which sends a message for requesting an upgrading of an RO to a certain entity (e.g., CI or RI) and receives a response message from the certain entity with respect to the RO-upgrading request (e.g., ROAP Request); and a processor which includes information related to the RO upgrading in the RO-upgrade-requesting message sent, analyzes information included in the response message received from the entity, and performs an RO acquisition protocol with the entity to acquire an upgraded RO.

Preferably, the device may further comprise: a memory which stores the upgraded RO acquired; a display which displays permissions and/or constraints to be added into the RO when accessing and browsing the entity; and an input unit which allows a user to select certain permission and/or constraint from the permissions and/or constraints displayed on the display.

To achieve this object of this disclosure, a method for sharing an RO between devices comprises: requesting, by a first device, an upgrading of a certain RO from a server (e.g., RI or CI) in order to share the certain RO; and acquiring, by the first device, an upgraded RO issued by the server.

FIG. 1 is a view of a construction of a DRM system.

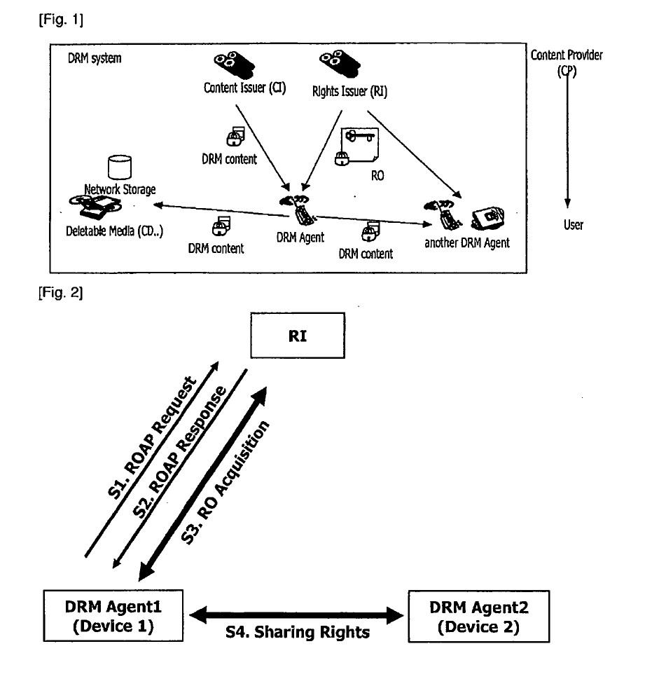

FIG. 2 is a block diagram schematically illustrating an RO sharing between devices according to this disclosure.

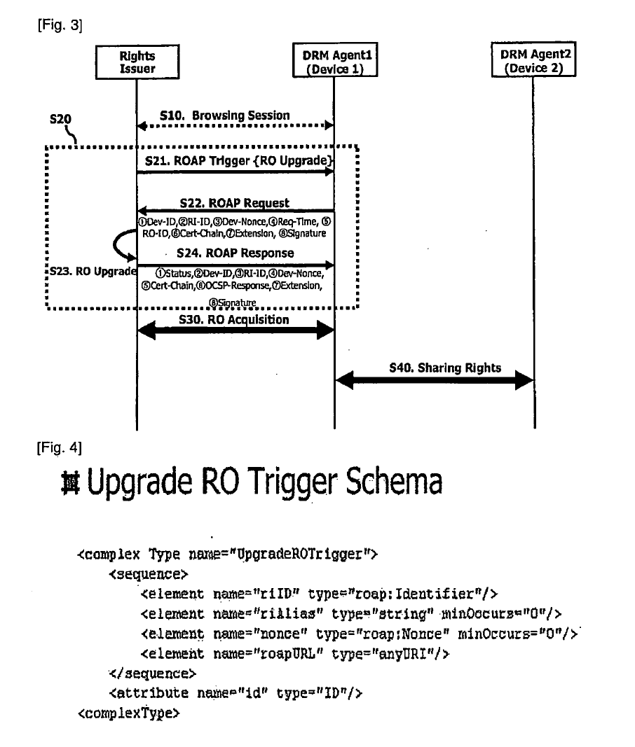

FIG. 3 is a signal flowchart illustrating a method for sharing an RO between devices in accordance with a first embodiment of this disclosure.

FIG. 4 is an exemplary view illustrating XML schema of a Upgrade RO trigger in accordance with one embodiment of this disclosure.

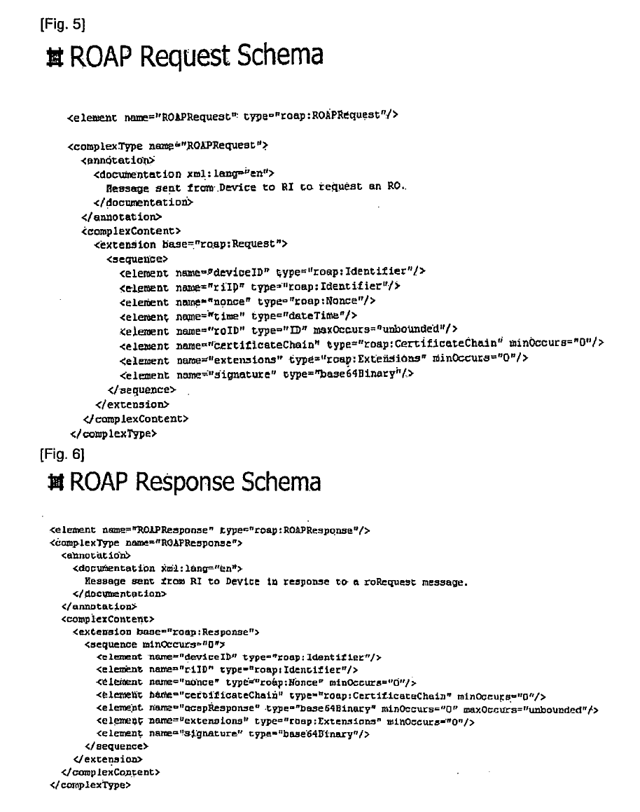

FIG. 5 is an exemplary view illustrating XML schema of a ROAP request message in accordance with one embodiment of this disclosure.

FIG. 6 is an exemplary view illustrating XML schema of a ROAP response message in accordance with one embodiment of this disclosure.

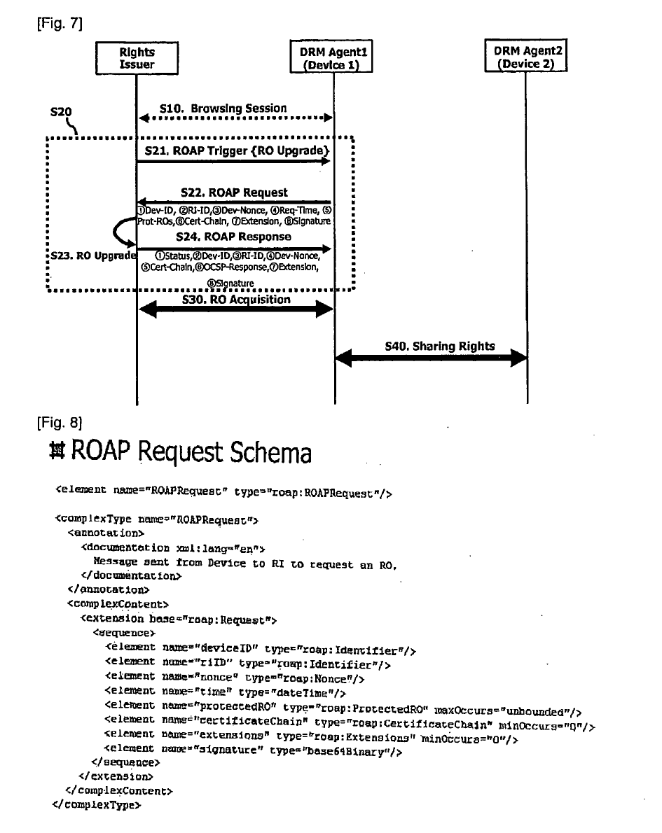

FIG. 7 is a signal flowchart illustrating a method for sharing an RO between devices in accordance with a second embodiment of this disclosure.

FIG. 8 is an exemplary view illustrating another XML schema of the ROAP request message according to this disclosure.

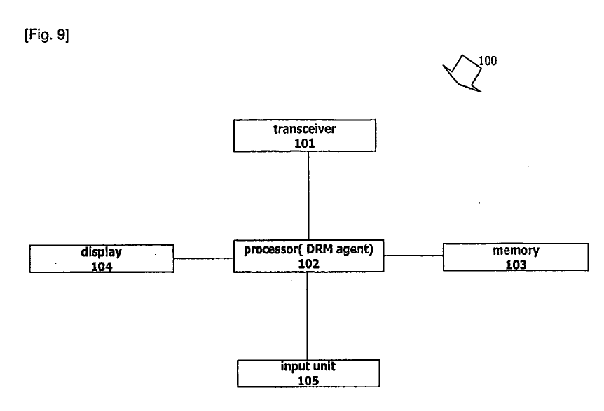

FIG. 9 is a block diagram illustrating a device in accordance with this disclosure.

This disclosure may be applied to wired/wireless communications systems related to a Digital Rights Management (DRM). However, this disclosure may not be limited thereto, but be applicable to any type of DRM related systems and devices.

Hereinafter, configurations and operations in the preferred embodiments of this disclosure will be described with reference to the accompanying drawings.

This disclosure basically relates to sharing a Rights Object (RO) for DRM contents between a specified device and at least one or more other devices. First, the specified device requests a sever (e.g., RI or CI) to upgrade its existing RO (i.e., one or more RO belonging to the specified device), and moves or copy an upgraded RO according to the request to the at least one or more other devices via wired/wireless media. The specified device can accordingly share the upgraded RO with the at least one or more other devices.

Terms used in this disclosure will briefly be described as follows.

RO sharing may denote using or consuming an RO between devices (a specified device and other device(s)) in a manner of moving (transferring), copying or lending the RO from the specified device to another device(s). Also, the RO sharing denotes using of the RO under a certain constraint (e.g., interval, or count) between devices in a manner of moving (transferring) or copying the RO from a specified device to another devices(s). This is especially called ‘Ad Hoc Sharing’.

RO upgrading may denote a type of authorization for an RO sharing (e.g., RO moving). For example, a specified device can share (e.g., move, copy or perform an Ad Hoc sharing for) an RO taken by the device or belonging to the device with at least one or more other devices by acquiring an RO having a move permission upgraded by the RI via a certain protocol (e.g., 2-pass updateRO protocol). Also, the RO upgrading may denote that a specified device upgrades an RO taken by itself into an appropriate format to share the RO with other devices. Accordingly, the RO may include permissions and/or constraints desired by a user. As such, the upgraded RO is acquired by processing the existing RO through the RO upgrading process by the RI or CI.

The terminal according to this disclosure may commonly denote a device, and may include all types of terminals capable of using digital contents. That is, terminals, namely, devices, according to this disclosure, may include mobile communications terminals (e.g., User Equipment (UE)) capable of using digital contents, mobile phones, cellular phones, DMB phones, DVB-H phones, PDA phones, PTT phones, etc.), digital TVs, GPS navigation, portable game machines, MP3, other home electronic or electrical alliances, etc. Thus, the terminal described in this disclosure may be the same as the device. In addition, the terminal of this disclosure may internally include a communication module, a Web/WAP browser, a DRM agent, media playback and library and a memory. In particular, the terminal (or device) of this disclosure may used as the same as the DRM agent for performing main functions.

ROs for DRM contents may be classified into stateful ROs and stateless ROs. The stateless RO indicates RO which a device does not manage state information. The stateful RO indicates RO which the device should manage state information such that permission and constraint indicated in the RO can appropriately be applied. The constraint managed by the state information may be interval, count, timed-count, accumulated, and the like.

Also, the state information may denote information related to remaining RO to be further usable, and one state information is managed for each stateful RO. For example, the state information can be managed depending on count or time, or depending on remaining count, or remaining time.

A connected device may denote a device capable of being directly connected to an RI (or CI) via a wired or wireless connection. An unconnected device may denote a device not capable of being directly connected to the RI.

FIG. 2 is a block diagram schematically illustrating an RO sharing between devices according to this disclosure. Here, at least one or more devices 2 sharing an RO with a device 1 in FIG. 2 may be employed, but only one device 2 is employed in the one embodiment of this disclosure for the sake of brief description thereof.

This disclosure may conceptually briefly be explained with reference to FIG. 2 as follows.

In this disclosure, in order for a specified device (e.g., device 1) to share an RO belonging to itself with at least one or more other devices (e.g., device 2), the device 1 may request an RI to upgrade its RO (e.g., request using a ROAP Request message) (S1). That is, the device 1 may request the RI to upgrade the RO by adding permission and/or constraint for sharing the RO with the device 2 to the RO. Here, the RO taken by the device 1 has been issued from the RI.

The RI may send a ROAP based response message (indicated as ROAP Response in FIG. 2) to the device 1 with respect to the request of the step S1. That is, the RI may add permission (e.g., move permission) and/or constraint to the RO or may change the permission and/or constraint, and then may inform the device 1 of the added or changed result (S2).

The device 1 may receive an upgraded RO issued by the RI via a ROAP based message through the steps S1 and S2 (S3). For example, the device 1 may receive the upgraded RO issued by the RI through ROAP-RO Request message and ROAP-RO Response message via DRM 2.0 RO Acquisition Protocol. On the other hand, the protocol in the step S3 may be referred to as 2-pass RO Acquisition Protocol. The device 1 may move or copy the upgraded RO acquired through the steps S1 to S3 to the device 2. Accordingly, the RO can be shared between the device 1 and the device 2 (S4). Here, the RO sharing may indicate, for example, copying, moving or Ad Hoc Sharing of the RO.

FIG. 3 is a signal flowchart illustrating a method for sharing an RO between devices in accordance with a first embodiment of this disclosure. In FIG. 3, the block diagram illustrated in FIG. 2 is described in more detail. However, the device 1 may denote a device used by a user 1 and the device 2 may denote a device used by a user 2. A specific RO which the user 1 desires to share may correspond to a specific RO among a plurality of ROs taken by the device 1 (or DRM agent 1, and referred to as ‘DRM agent 1’ hereafter) of the user 1, and the user 1 has already purchased the specific RO from an RI (or CI).

As illustrated in FIG. 3, the first embodiment of this disclosure may include a preparation step (S20) in which a DRM agent 1 is intended to upgrade an RO belonging to itself by exchanging messages with the RI, an acquisition step (S30) in which the DRM agent 1 substantially acquires an upgraded RO from the RI, and a sharing step (S40) in which the DRM agent 1 shares the upgraded RO with another device (i.e., device 2 in FIG. 3) (e.g., moves the upgraded RO to the another device). Hereinafter, description of the first embodiment will be made in detail with reference to FIG. 3.

In order for the user 1 to share a previously-purchased RO with other users using other devices (e.g., another device belonging to him or a third party's device), the RO should be upgraded. That is, the user 1 may access a portal web site of a Contents Issuer (CI) (or RI) by using the device 1. The user 1 then may select at least one or more permissions (e.g., permission for move, Ad Hoc sharing, copy, etc.) and/or constraints (e.g., count or time) that the user 1 desires. The user 1 then may request to upgrade the specific RO such that the RO taken by the device 1 includes (adds) the selected at least one or more permissions and/or constraints (S10). The step 10 may be optional.

After the step S10, a series of steps (S20) for upgrading the RO may be performed between the DRM agent 1 and the RI.

That is, the RI may send a ROAP Trigger message (or signal) for the RO upgrading to the DRM agent 1, the ROAP Trigger message informing that a protocol for the RO upgrading is to be performed (S21). Here, in the step S21, the DRM agent 1 may download the ROAP Trigger message in a XML schema format as illustrated in FIG. 4, and then may perform the following steps (i.e., S22 and S23).

The DRM agent 1 may request the RI to upgrade a previously-issued specific RO in order to share it with the DRM agent 2 (i.e. device 2) (S22). Here, the upgrading of the specific RO indicates that the DRM agent 1 adds, for example, permissions and/or constraints to the specific RO. On the other hand, one example of the XML schema format of the upgrade request message (i.e., ROAP Request in FIG. 3) may be illustrated in FIG. 5.

In the step S22, the DRM agent 1 may send a so-called upgrade request message (i.e., ‘ROAP Request’ message in FIG. 3) to the RI to request the RO upgrading. Here, the upgrade request message, as illustrated in FIG. 5, may include at least one or more information related to the RO upgrading. These information may be types of parameters or elements, example of which may be as follows:

\textcircled{1} Dev-ID: Device Identification (ID) of the DRM agent 1;

\textcircled{2} RI-ID: ID of the RI;

\textcircled{3} Dev-Nonce: Random value generated by the DRM agent 1;

\textcircled{4} Req-Time: current DRM Time;

\textcircled{5} RO-ID: Identification of RO to be upgraded;

\textcircled{6} Cert-Chain: Certificate chain including a device certificate;

\textcircled{7} Extension: Parameter for extension, which may include PKI (Peer Key Identifier, No OCSP Response, OCSP Responder Key Identifier, Transaction Identifier and the like; and

\textcircled{8} Signature: RSA Digital Signature for a message.

Here, the Cert-chain among those information may be optional.

The RI may receive the ROAP Request message from the DRM agent 1, and interpret (or analyzes) information included in the message, thereby upgrading the specific RO identified by the RO-ID (S23). That is, the RI may add the items (permissions and/or constraints) upgrading-requested by the user 1 in the step S10 to the specific RO, thereby upgrading the RO.

One example of the XML schema format of the ROAP response message may be illustrated in FIG. 6.

The RI may send a response message (e.g. ROAP Response message in FIG. 3) to the DRM agent 1 with respect to the ROAP request message of the step S22 (S24). Here, the ROAP Response message may include at least one or more information indicating the result of the upgrading request. These information may be included in the response message as parameters or elements as illustrated in FIG. 6, example of which is described as follows:

\textcircled{1} Status: Result of the RO upgrade through the ROAP Request of the DRM agent 1;

\textcircled{2} Dev-ID: Device Identification (ID) of the DRM agent 1;

\textcircled{3} RI-ID: ID of the RI;

\textcircled{4} Dev-Nonce: Random value of the DRM agent 1;

\textcircled{5} Cert-Chain: Certificate chain of the device certificate;

\textcircled{6} OCSP-Response (optional): OCSP Response with respect to the Cert-chain of the RI;

\textcircled{7} Extention: Parameter for extension, which may include PKI (Peer Key Identifier, No OCSP Response, OCSP Responder Key Identifier, Transaction Identifier and the like); and

\textcircled{8} Signature: RSA Digital Signature for a message.

Here, the ‘Cert-chain’ among those information may be optional. Also, the status element (or parameter) may include ‘accept’ or ‘reject’ information for the RO upgrading request of the DRM agent 1, and may further include status information related to the RO upgrading. If the RI can not accept the RO-upgrading request of the DRM agent 1, the status element may have a type of error message (or signal) to be sent from the RI to the DRM agent 1. Accordingly, the user 1 can check the information (i.e., the error message) included in the status element of the ROAP Response message and then be informed that the RO can not be upgraded. Besides, the status element may include status information related to the RO upgrading.

The RI may issue the RO upgraded by the RI to the DRM agent 1 (S30).

The DRM agent 1 can share the upgraded RO acquired through the step S30 with the device 2, namely, the DRM agent 2 (S40). For example, when the DRM agent 1 moves the upgraded RO to the DRM agent 2, the DRM agent 2 may use the upgraded RO. In addition, when the DRM agent 1 moves the upgraded RO to the DRM agent 2 for an Ad Hoc Sharing, the DRM agent 1 may use the upgraded RO together with the DRM agent 2 temporarily or for a certain period. Besides, the DRM agent 1 can share the upgraded RO with the DRM agent 2 by copying it into the DRM agent 2.

FIG. 7 is a signal flowchart illustrating a method for sharing an RO between devices in accordance with a second embodiment of the present invention. FIG. 7 illustrates the block diagram of FIG. 2 in more detail. The second embodiment of FIG. 7 is similar to the first embodiment of FIG. 3, except for the upgrade request message sent from the DRM agent 1 to the RI. Therefore, the same reference numerals in FIGS. 3 and 7 indicate equivalent operations and functions. Also, the explanation of the first embodiment of FIG. 3 is equally applied to the second embodiment of FIG. 7.

In the second embodiment of FIG. 7, the upgrade requesting message (i.e., ROAP Request message in FIG. 8) sent from the DRM agent 1 to the RI has Prot-ROs as one information (indicated as ‘protectedRO’ in FIG. 8) instead of the RO-ID which is included in the upgrade requesting message in the first embodiment of FIG. 3. That is, comparing with the upgrade requesting message in the step S22 of FIG. 3, the upgrade requesting message illustrated in the step S22 in FIG. 7 (i.e., ‘ROAP Request’ message in FIG. 7) may include at least one or more information related to the RO upgrading. These information may be types of parameters or elements, example of which may be as follows:

\textcircled{1} Dev-ID: Device Identification (ID) of the DRM agent 1;

\textcircled{e} RI-ID: ID of the RI;

\textcircled{3} Dev-Nonce: Random value generated by the DRM agent 1;

\textcircled{4} Req-Time: current DRM Time;

\textcircled{5} Prot-ROs: issued to the DRM agent 1 by the RI, and in a format of <protectedRO> element;

\textcircled{6} Cert-Chain: Certificate chain including a device certificate;

\textcircled{7} Extension: Parameter for extension, which may include PKI (Peer Key Identifier, No OCSP Response, OCSP Responder Key Identifier, Transaction Identifier and the like; and

\textcircled{8} Signature: RSA Digital Signature for a message.

Here, the Prot-ROs as one information may have been issued to the DRM agent 1 by the RI. The Pro-ROs may be configured in a format of <protectedRO> element (or parameter) as in the XML schema format illustrated in FIG. 8. Also, the Prot-ROs may include a <rights> element, a digital signature for the <rights> element and REK. Here, the <rights> element may include CEK (Content Encryption Key), permission, constraint, and the like. In other words, a protected RO may be configured to contain RO, digital signature and REK.

Hereinafter, a device (or terminal) according to this disclosure may be described with reference to FIG. 9 as follows. The device according to this disclosure may have the DRM agent illustrated with reference to FIGS. 2 to 8. That is, the device 100 according to this disclosure may include a transceiver 101 which sends a message for requesting an RO upgrading (or updating) (e.g., ROAP Request) to the RI (or CI), and receives a response message (e.g., ROAP Response) from the RI with respect to the RO-upgrading request.

The device 100 according to this disclosure may further include a processor 102 which includes (adds) information related to the RO upgrading in the RO-upgrading requesting message, and analyzes information included in the response message received from the RI. The processor 102 may correspond to the DRM agent. Also, the processor 102 performs 2-pass RO acquisition protocol to acquire an upgraded RO from the RI.

The device 100 according to this disclosure may further include a memory 103 which stores the upgraded RO acquired from the RI.

The device 100 according to this disclosure may further include a display 104 which displays permissions and/or constraints to be added to the RO for the RO sharing upon accessing and browsing a portal site of the RI. The device 100 according to this disclosure may further include an input unit 105 which allows a user to select his desirable permission and/or constraint from the permissions and/or constraints displayed on the display.

In addition, function and operation of each component of the device 100 according to this disclosure can be understood by the description made with reference to FIGS. 2 to 8.

However, in addition to the components illustrated in FIG. 9, the device 100 according to this disclosure may comprise essential components of a device (i.e., terminal) required to use DRM contents, which is obvious to those skilled in the art. Thus, description of the essential components will be omitted.

As described above, this disclosure has been explained with reference to the embodiments which are merely exemplary. It will be apparent to those skilled in the art that various modifications and variations can be made in this disclosure. For example, the messages (i.e., ROAP Request and ROAP Response) exchanged between the RI and the DRM agent 1 (or device 1) for the RO upgrading is for the RO acquisition. However, the ROAP Response message may include the RO upgraded by the RI to be sent from the RI to the DRM agent 1 (or device 1). Thus, it is intended that this disclosure cover modifications and variations of this invention provided they come within the scope of the appended claims and their equivalents.

As described above, in the method and device for sharing an RO between devices of this disclosure, a certain device requests the RI to upgrade an RO taken by the device, and accordingly the upgraded RO can be shared between the certain device and other device(s).

1. A method for sharing a Rights Object (RO) between devices comprising: sending, by a first device, to a server a message for requesting an upgrading of a certain RO, in order to share the certain RO;
receiving, by the first device, from the server a response message with respect to the request message; and
acquiring, by the first device, an upgraded RO from the server.

2. The method of claim 1, further comprising:
receiving, by the first device, from the server a message for triggering RO upgrade, before sending to the server the message for requesting RO upgrade.

3. The method of claim 1, further comprising:
sharing the upgraded RO between the first device and a second device.

4. The method of claim 3, wherein the sharing of the upgraded RO includes:
moving the upgraded RO from the first device to the second device;
copying the upgrade RO from the first device to the second device; or
performing an Ad Hoc Sharing for the upgraded RO between the first device and the second device.

5. The method of claim 1, wherein the request message includes at least one or more information for the RO upgrading.

6. The method of claim 5, wherein the information includes an identification of the RO.

7. The method of claim 5, wherein the information includes a Prot-ROs element.

8. The method of claim 5, wherein the information includes at least one or more of:
a parameter indicating an ID of the first device;
a parameter indicating an ID of the server;
a Dev-Nonce parameter;
a Req-Time parameter;
a Cert-Chain parameter;
an extension parameter; and
a signature parameter.

9. The method of claim 1, wherein the response message includes:
an acceptance or rejection for the RO upgrading request; and
information indicating a state of the RO upgrading.

10. The method of claim 9, wherein the response message includes at least one or more of:
a parameter indicating an ID of the first device;
a parameter indicating an ID of the server;
a Dev-Nonce parameter;
a Req-Time parameter;
a Cert-Chain parameter;
an OCSP-Response parameter;
an extension parameter; and
a signature parameter.

11. The method of claim 1, wherein the server is Rights Issuer (RI) or Contents Issuer (CI).

12. A method for sharing a Rights Object (RO) between devices comprising:
requesting, by the first device, a server to upgrade a certain RO, in order to share the certain RO with at least one or more second devices;
receiving, by the first device, a response from the server with respect to the RO upgrading request; and
receiving, by the first device, an upgraded RO issued by the server based upon state information in the received response.

13. The method of claim 12, wherein the information includes an identification of the RO.

14. The method of claim 12, wherein the information includes a Prot-ROs element.

15. The method of claim 12, wherein the request for the RO upgrading by the first device includes at least one or more of:
a parameter indicating an ID of the first device;
a parameter indicating an ID of the server;
a Dev-Nonce parameter;
a Req-Time parameter;
a Cert-Chain parameter;
an extension parameter; and
a signature parameter.

16. The method of claim 12, wherein the response with respect to the RO upgrading request includes:
an acceptance or rejection for the RO upgrading request; and
information indicating a state of the RO upgrading.

17. The method of claim 16, wherein the response with respect to the RO upgrading request includes at least one or more of:
a parameter indicating an ID of the first device;
a parameter indicating an ID of the server;
a Dev-Nonce parameter;
a Req-Time parameter;
a Cert-Chain parameter;
an OCSP-Response parameter;
an extension parameter; and
a signature parameter.

18. The method of claim 12, wherein the sharing of the RO includes:
moving the upgraded RO from the first device to the second device;
copying the upgrade RO from the first device to the second device; or
performing an Ad Hoc Sharing for the upgraded RO between the first device and the second device.

19. The method of claim 12, wherein the server is Rights Issuer (RI) or Contents Issuer (CI).

20. A device comprising:
a transceiver which sends a message for requesting an RO upgrading to a certain entity, and receives a response message from the entity with respect to the RO upgrading request; and
a processor which includes information related to the RO upgrading in the RO-upgrade-requesting message sent, analyzes information included in the response message sent by the entity, and acquires an upgraded RO by performing an RO acquisition protocol with the entity.

21. The device of claim 20, wherein the processor is a Device Rights Management (DRM) agent.

22. The device of claim 20, further comprising:
a memory which stores the upgraded RO acquired;
a display which displays permissions and/or constraints to be added into the RO upon accessing and browsing the entity; and
an input unit which allows a user to select certain permission and/or constraint from the permissions and/or constraints displayed on the display.

23. The device of claim 20, wherein the certain entity is a Contents Issuer (CI) or a Rights Issuer (RI).

24. A method for sharing a Rights Object (RO) between devices comprising:
requesting, by a first device, an upgrading of a certain RO from a server in order to share the certain RO; and
acquiring, by the first device, an upgraded RO issued by the server according to the RO upgrading request.

25. The method of claim 24, wherein the acquiring step comprises:
receiving, by the first device, a response message from the server with respect to the RO upgrading request.

26. The method of claim 24, further comprising:
sharing the upgraded RO between the first device and a second device.

27. The method of claim 26, wherein the sharing of the upgraded RO includes:
moving the upgraded RO from the first device to the second device;
copying the upgrade RO from the first device to the second device; or
performing an Ad Hoc Sharing for the upgraded RO between the first device and the second device.

28. The method of claim 24, wherein the first device sends at least one or more information for the RO upgrading to the server when the first device requests the RO upgrading.

29. The method of claim 28, wherein the information includes an identification of the RO.

30. The method of claim 28, wherein the information includes a Prot-ROs element.

31. The method of claim 28, wherein the information includes at least one or more of:
a parameter indicating an ID of the first device;
a parameter indicating an ID of the server;
a Dev-Nonce parameter;
a Req-Time parameter;
a Cert-Chain parameter;
an extension parameter; and
a signature parameter.

32. The method of claim 25, wherein the response message includes:
an acceptance or rejection for the RO-upgrading request; and
information indicating a state of the RO upgrading.

33. The method of claim 32, wherein the response message includes at least one or more of:
a parameter indicating an ID of the first device;
a parameter indicating an ID of the server;
a Dev-Nonce parameter;
a Req-Time parameter;
a Cert-Chain parameter;
an OCSP-Response parameter;
an extension parameter; and
a signature parameter.

34. The method of claim 24, wherein the server is Rights Issuer (RI) or Contents Issuer (CI).
